(19) United States
(12) Patent Application Publication
(10) Pub. No.: US 2026/0139960 A1
(43) Pub. Date: May 21, 2026

(54) DISPLAY APPARATUS

(71) Applicant: SUBARU CORPORATION, Tokyo (JP)

(72) Inventors: Tsukasa MIKUNI, Tokyo (JP); Ryota NAKAMURA, Tokyo (JP); Junichi MOTOYAMA, Tokyo (JP); Yuto AOKI, Tokyo (JP); Takeshi SAITO, Tokyo (JP)

(21) Appl. No.: 19/450,279

(22) Filed: Jan. 15, 2026

Related U.S. Application Data
(63) Continuation of application No. PCT/JP2023/030315, filed on Aug. 23, 2023.

(51) Int. Cl. G01C 21/36

(52) U.S. Cl. CPC G01C 21/3697

(57) ABSTRACT

A display apparatus includes a traveling route acquirer, a vehicle data acquirer, a merging point detector, a required time calculator, a display information generator, and a display. The merging point detector is configured to detect a merging point, based on a traveling route of a first vehicle to a destination acquired by the traveling route acquirer and a traveling route of a second vehicle to a destination acquired by the vehicle data acquirer. The required time calculator is configured to calculate, at predetermined time intervals, a difference between a first vehicle required time and a second vehicle required time. The display information generator is configured to generate display information on the merging point and the difference between the first vehicle required time and the second vehicle required time. The display is configured to display the display information.

### CROSS-REFERENCE TO RELATED APPLICATIONS

This application is continuation of International Application No. PCT/JP2023/030315, filed on Aug. 23, 2023, the entire contents of which are hereby incorporated by reference.

### BACKGROUND

The disclosure relates to a display apparatus.

In general, a navigation device of a vehicle displays information such as a traveling route to a set destination or an estimated arrival time, and performs a route guidance to the destination.

For example, Japanese Unexamined Patent Application Publication (JP-A) No. 2008-82795 discloses a technique in which an estimated arrival time to a destination is calculated at predetermined time intervals, and a notifier notifies that the calculated estimated arrival time and the estimated arrival time calculated after a predetermined time are deviated from each other by a predetermined time or more, when the deviation occurs.

### SUMMARY

An aspect of the disclosure provides a display apparatus configured to be applied to a first vehicle. The display apparatus includes a traveling route acquirer, a vehicle data acquirer, a merging point detector, a required time calculator, a display information generator, and a display. The traveling route acquirer is configured to acquire a traveling route of the first vehicle to a destination. The vehicle data acquirer is configured to acquire a traveling route of a second vehicle to the destination and position data of the second vehicle. The merging point detector is configured to detect a merging point, based on the traveling route of the first vehicle to the destination and the traveling route of the second vehicle to the destination. The required time calculator is configured to calculate, at predetermined time intervals, a difference between a first vehicle required time and a second vehicle required time. The first vehicle required time is a time required for the first vehicle to reach the merging point. The second vehicle required time is a time required for the second vehicle to reach the merging point. The display information generator is configured to generate display information on the merging point and the difference between the first vehicle required time and the second vehicle required time. The display is configured to display the display information.

An aspect of the disclosure provides a display apparatus configured to be applied to a first vehicle. The display apparatus includes one or more processors, one or more memories communicably coupled to the one or more processors, and a display. The one or more processors are configured to: acquire a traveling route of a first vehicle to a destination; acquire a traveling route of a second vehicle to the destination and position data of the second vehicle; detect a merging point, based on the traveling route of the first vehicle to the destination and the traveling route of the second vehicle to the destination; calculate, at predetermined time intervals, a difference between a first vehicle required time and a second vehicle required time, in which the first vehicle required time is a time required for the first vehicle to reach the merging point and the second vehicle required time is a time required for the second vehicle to reach the merging point; generate display information on the merging point and the difference between the first vehicle required time and the second vehicle required time; and display the display information on the display.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of a display apparatus according to one example embodiment of the disclosure.

FIG. 2 is a diagram illustrating a configuration of a processor of the display apparatus illustrated in FIG. 1.

FIG. 3 is a diagram illustrating a merging point calculated by the display apparatus illustrated in FIG. 1.

FIG. 4 is a diagram illustrating an example of displaying of the display apparatus illustrated in FIG. 1.

FIG. 5 is a flowchart of a process to be performed by the display apparatus illustrated in FIG. 1.

### DETAILED DESCRIPTION

A technique disclosed in JP-A No. 2008-82795 makes it difficult for respective vehicles that travel in a group to acquire data such as data on a traveling route from another vehicle that travels in the group, when those vehicles travel in the group to the same destination and whose departure points are different from each other. Accordingly, it is difficult for drivers who drive their respective vehicles to grasp a merging point of the vehicles that travel in the group.

In addition, the technique disclosed in JP-A No. 2008-82795 is devoid of a system that notifies information on a time to arrive at the merging point of the vehicles that travel in the group. Accordingly, it is difficult for the drivers to determine whether there is a time margin.

It is desirable to provide a display apparatus that notifies a driver who drives an own vehicle of information such as information on a merging point of vehicles that travel in a group or information on a time at which the vehicles arrive at the merging point.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Example Embodiment

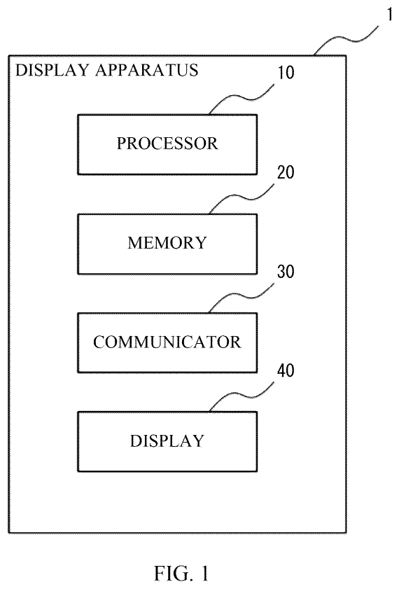

A display apparatus 1 according to an example embodiment will be described with reference to FIGS. 1 to 5.

### Configuration of Display Apparatus 1

Referring to FIG. 1, the display apparatus 1 according to the example embodiment includes a processor 10, a memory 20, and a display 40. The display apparatus 1 may include a communicator 30.

The processor 10 causes information on a merging point of routes along which respective vehicles travel in a group to the same destination and information on a time at which those vehicles arrive at the merging point to be displayed.

A configuration of the processor 10 will be described later.

The memory 20 may be or may include an unillustrated read-only memory (ROM) and an unillustrated random-access memory.

The memory 20 may contain, for example, a control program, map data, and various pieces of data received from the processor 10.

In the example embodiment, the memory 20 may contain group traveling data registered in advance by drivers who drive their respective vehicles when the group traveling is to be started.

Non-limiting examples of the group traveling data may include an identification number of each vehicle that perform the group traveling, destination data of each vehicle that performs the group traveling, and mail address data of the driver of each vehicle.

The communicator 30 may be a wireless communication module connectable to a network.

The communicator 30 may communicate with the vehicles that perform the group traveling via, for example, an Internet network.

The display 40 may be any display such as a liquid crystal display. The display 40 displays a piece of display information received from the processor 10.

### Configuration of Processor 10

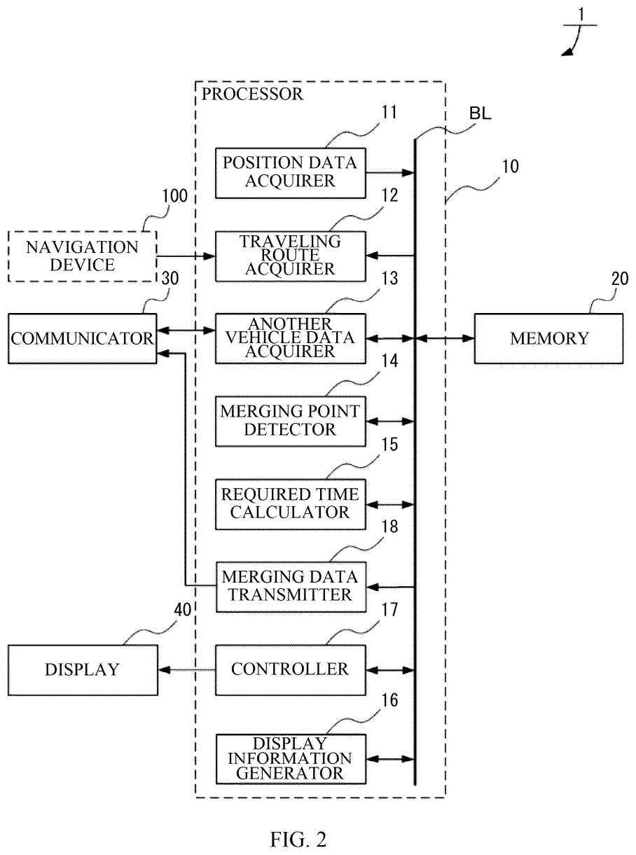

Referring to FIG. 2, the processor 10 includes a traveling route acquirer 12, another vehicle data acquirer 13, a merging point detector 14, a required time calculator 15, and a display information generator 16. The processor 10 may include a position data acquirer 11. In one embodiment, the another vehicle data acquirer 13 may serve as a “vehicle data acquirer”.

Each part of the processor 10 and the memory 20 may transmit and receive various types of data via a bus line BL.

Hereinafter, the processor 10 of the display apparatus 1 provided in an own vehicle will be described out of the own vehicle and another vehicle as the vehicles that perform the group traveling toward the same destination. In one embodiment, the own vehicle may serve as a “first vehicle”. In one embodiment, another vehicle or the other vehicle may serve as a “second vehicle”.

The position data acquirer 11 may acquire position data of the own vehicle.

The position data acquirer 11 may acquire a current position of the own vehicle, based on radio waves received from a global positioning system (GPS).

The position data acquirer 11 may transmit the acquired position data of the own vehicle to a later-described controller 17 via the bus line BL.

The traveling route acquirer 12 acquires a traveling route of the own vehicle to a destination.

In some embodiments, the traveling route acquirer 12 may acquire data on the traveling route of the own vehicle to the destination, from a device such as a navigation device 100 mounted on the own vehicle.

The traveling route acquirer 12 may transmit the acquired traveling route of the own vehicle to the later-described controller 17 via the bus line BL.

The another vehicle data acquirer 13 acquires the traveling route of the other vehicle to the destination and position data of the other vehicle.

The another vehicle data acquirer 13 may communicate with the other vehicle registered in the group traveling data stored in the memory 20 via the communicator 30.

In some embodiments, the another vehicle data acquirer 13 may acquire, via the communicator 30, the data on the traveling route to the destination calculated by the other vehicle and the position data of the other vehicle.

The another vehicle data acquirer 13 may transmit the traveling route of the other vehicle and the position data of the other vehicle to the later-described controller 17 via the bus line BL.

The merging point detector 14 detects a merging point, based on the traveling route of the own vehicle to the destination and the traveling route of the other vehicle to the destination.

In some embodiments, the merging point detector 14 may detect, as the merging point, a point at which the traveling route of the own vehicle to the destination and the traveling route of the other vehicle to the destination first intersect with each other.

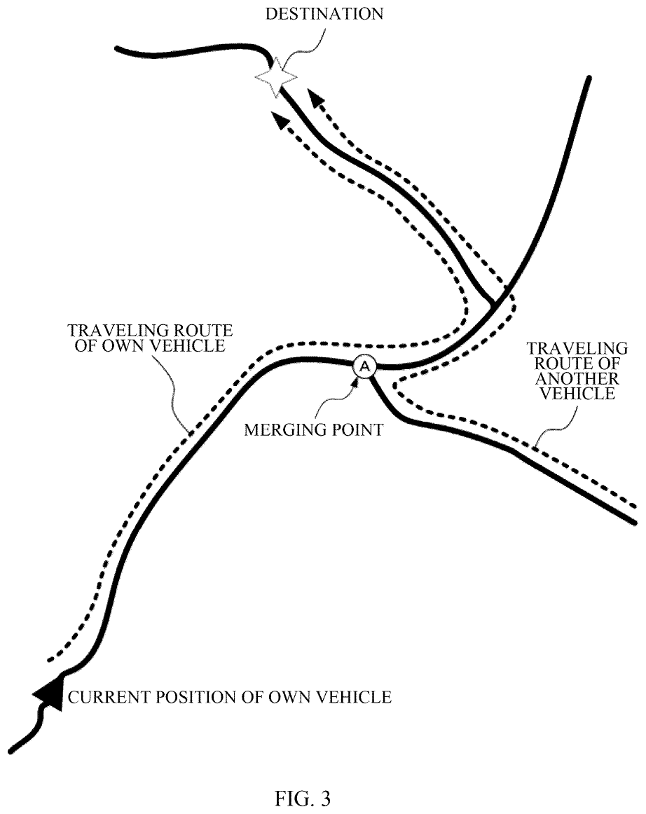

Referring to FIG. 3, for example, the merging point detector 14 may detect, as the merging point, a point A at which the traveling route of the own vehicle to the destination and the traveling route of the other vehicle to the destination first intersect with each other.

The merging point detector 14 may transmit detected position data of the merging point to the later-described controller 17 via the bus line BL.

The required time calculator 15 calculates a required time of the own vehicle and a required time of the other vehicle. The required time of the own vehicle is a time required for the own vehicle to reach the merging point. The required time of the other vehicle is a time required for the other vehicle to reach the merging point. In one embodiment, the required time of the own vehicle may serve as a “first vehicle required time”. In one embodiment, the required time of the other vehicle serve as a “second vehicle required time”.

The required time calculator 15 may calculate a traveling distance from the current position of the own vehicle to the merging point, based on map data acquired from the memory 20, the position data of the own vehicle received from the later-described controller 17, and position data of the merging point.

In some embodiments, the required time calculator 15 may calculate the required time of the own vehicle, based on: the traveling distance from the current position of the own vehicle to the merging point; and an average speed of the own vehicle.

The required time calculator 15 may calculate the traveling distance from the current position of the other vehicle to the merging point, based on the map data acquired from the memory 20, the position data of the other vehicle received from the controller 17, and the position data of the merging point.

In some embodiments, the required time calculator 15 may calculate the required time of the other vehicle, based on: the traveling distance from the current position of the other vehicle to the merging point; and a legal speed of the traveling route of the other vehicle.

In the example embodiment, the required time calculator 15 calculates, for example, a time difference between the required time of the own vehicle and the required time of the other vehicle.

The required time calculator 15 may transmit, to the later-described controller 17 via the bus line BL, the calculated required time of the own vehicle, the calculated required time of the other vehicle, and the calculated time difference between the required time of the own vehicle and the required time of the other vehicle.

The display information generator 16 generates display information. In some embodiments, the display information may include information on the merging point, the required time of the own vehicle, and the required time of the other vehicle.

The display information generator 16 may generate the display information on the merging point, the required time of the own vehicle, and the required time of the other vehicle, based on: the position data on the own vehicle; the traveling route of the own vehicle; the traveling route of the other vehicle; the position data on the merging point, the required time of the own vehicle; and the required time of the other vehicle, that are received from the controller 17.

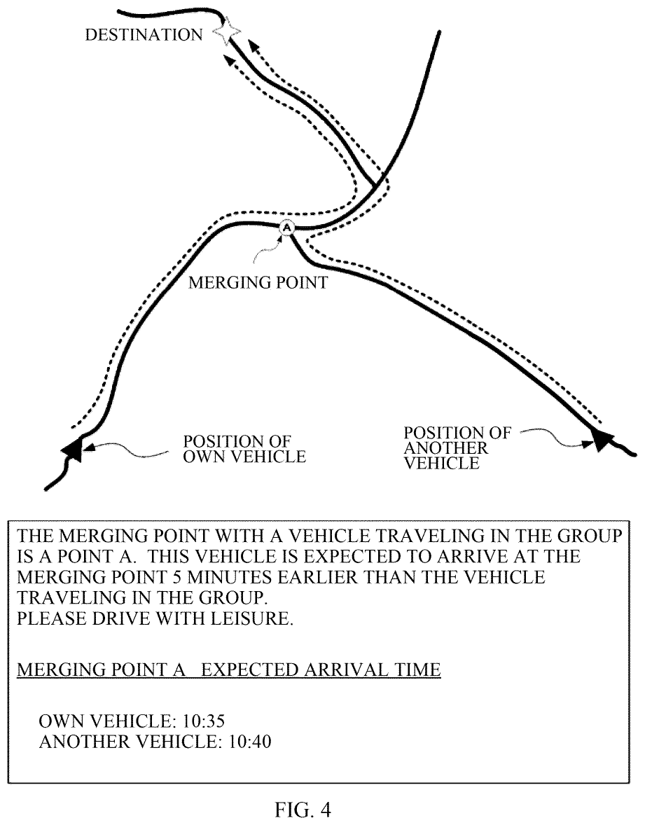

Referring to FIG. 4, the display information generator 16 may generate the display information indicating the position of the destination, the position of the own vehicle, the position of the other vehicle, and the position of the merging point.

For example, the display information generator 16 may generate the display information including text information such as “The merging point with a vehicle traveling in the group is a point A. This vehicle is expected to arrive at the merging point 5 minutes earlier than the vehicle traveling in the group. Please drive with leisure”.

In some embodiments, the display information generator 16 may generate the display information including an expected arrival time of the own vehicle and the other vehicle at the merging point.

The display information generator 16 may transmit the generated display information to the later-described controller 17 via the bus line BL.

The controller 17 may control the display apparatus 1 as a whole, based on the control program stored in the memory 20.

In the example embodiment, the controller 17 may determine, for example, whether an input of the group traveling data is received.

For example, the controller 17 may determine whether the input of the group traveling data is received from an unillustrated operation member.

The controller 17 may store the group traveling data in the memory 20 via the bus line BL, when the group traveling data is received.

In the example embodiment, the controller 17 may control the display 40 to display pieces of information on the merging point, the required time of the own vehicle, and the required time of the other vehicle.

The controller 17 may transmit, to the display 40, the display information received from the display information generator 16.

In the example embodiment, the controller 17 may execute, on a later-described merging data transmitter 18, a control designed to transmit, to the other vehicle, data on the merging point, the required time of the own vehicle, and the required time of the other vehicle.

For example, the controller 17 may transmit, to the later-described merging data transmitter 18 via the bus line BL, the position data on the own vehicle, the position data on the merging point, the required time of the own vehicle, and the required time of the other vehicle.

The merging data transmitter 18 may transmit, to the other vehicle, the data on the merging point, the required time of the own vehicle, and the required time of the other vehicle.

For example, the merging data transmitter 18 may transmit, to the communicator 30, the position data on the own vehicle, the position data on the merging point, the required time of the own vehicle, and the required time of the other vehicle that are received from the controller 17.

In some embodiments, the merging data transmitter 18 may transmit, via the communicator 30, the data described above to a mail address of a driver who drives the other vehicle registered in the group traveling data.

### Process of Display Apparatus 1

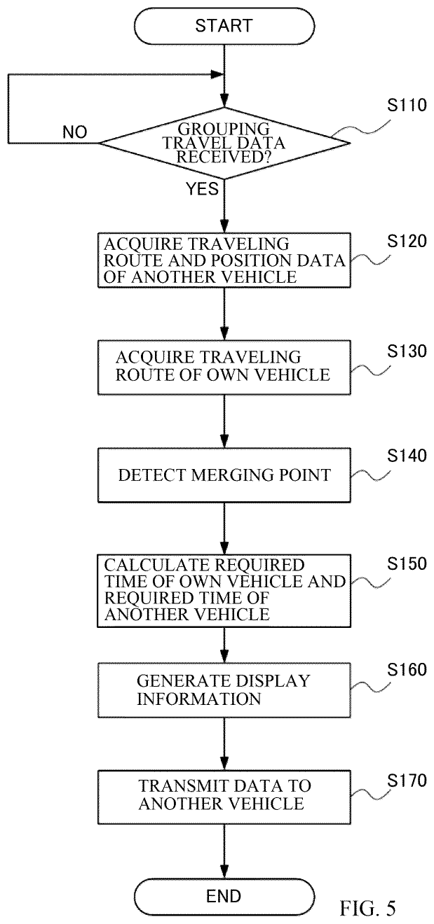

An example flow of a process to be performed by the display apparatus 1 will be described with reference to FIG. 5.

Referring to FIG. 5, the controller 17 may determine whether the grouping travel data is received (step S110).

If the controller 17 determines that the grouping travel data is not received (“NO” in step S110), the process may return to a standby mode.

If the controller 17 determines that the grouping travel data is received (“YES” in step S110), the controller 17 may shift the process to step S120.

The controller 17 may transmit, to the another vehicle data acquirer 13, an instruction to acquire data on the other vehicle, and cause the another vehicle data acquirer 13 to acquire the traveling route of the other vehicle to the destination and the position data of the other vehicle (step S120).

The controller 17 may transmit, to the traveling route acquirer 12, an instruction to acquire the traveling route of the own vehicle to the destination, and cause the traveling route acquirer 12 to acquire the data on the traveling route of the own vehicle to the destination from the navigation device 100 (step S130).

The controller 17 may transmit, to the merging point detector 14, the traveling route of the own vehicle to the destination and the traveling route of the other vehicle to the destination, and cause the merging point detector 14 to detect the merging point (step S140).

The controller 17 may transmit, to the required time calculator 15, the position data of the own vehicle, the position data of the other vehicle, and the position data of the merging point, and cause the required time calculator 15 to calculate the required time of the own vehicle and the required time of the other vehicle (step S150).

The controller 17 may transmit, to the display information generator 16, the position data of the own vehicle, the traveling route of the own vehicle, the traveling route of the other vehicle, the position data of the merging point, the required time of the own vehicle, and the required time of the other vehicle, and cause the display information generator 16 to generate the display information (step S160).

The controller 17 may transmit, to the merging data transmitter 18, the position data of the merging point, the required time of the own vehicle, and required time of the other vehicle, and cause the merging data transmitter 18 to transmit, to the other vehicle, the data on the merging point, the required time of the own vehicle, and the required time of the other vehicle (step S170). Thereafter, the controller 17 may end the process.

### Workings and Example Effects

The display apparatus 1 according to the example embodiment includes: the traveling route acquirer 12, the merging point detector 14, the required time calculator 15, the display information generator 16, and the display 40. The traveling route acquirer 12 is configured to acquire the traveling route of the own vehicle to the destination. The another vehicle data acquirer 13 is configured to acquire the traveling route of the other vehicle to the destination and the position data of the other vehicle. The merging point detector 14 is configured to detect the merging point, based on the traveling route of the own vehicle to the destination and the traveling route of the other vehicle to the destination. The required time calculator 15 is configured to calculate the time required for the own vehicle to reach the merging point and the time required for the other vehicle to reach the merging point. The display information generator 16 is configured to generate the display information on the required time of the own vehicle, the required time of the other vehicle, and the merging point. The display 40 is configured to display the display information.

For example, the display apparatus 1 is configured to detect the merging point at which the own vehicle and the other vehicle merge, based on the traveling route of the own vehicle to the destination and the traveling route of the other vehicle to the destination, and cause the display 40 to display the information on the detected merging point.

This configuration helps to allow the driver of the own vehicle to grasp the merging point at which the own vehicle is to merge with the other vehicle.

In some embodiments, the display apparatus 1 may be configured to cause the display 40 to display information such as how late the own vehicle arrives at the merging point or how fast the own vehicle arrives at the merging point, based on the required time of the own vehicle and the required time of the other vehicle.

This configuration helps to allow the driver of the own vehicle to grasp a traveling state of each vehicle that travels in the group.

For example, this configuration helps to allow the driver of the own vehicle to determine whether there is a time margin to stop at a facility such as a convenience store, based on the information displayed on the display 40, and to effectively utilize the time.

Further, for example, when information indicating that the own vehicle arrives at the merging point 10 minutes earlier than the other vehicle is displayed on the display 40, the driver of the own vehicle is able to perform the safe driving with a speed of the own vehicle lowered.

In some embodiments, the display information generator 16 may be configured to generate the display information that includes the position of the destination, the position of the own vehicle, the position of the other vehicle, and the position of the merging point.

In other words, the display apparatus 1 visualizes and displays the position of the destination, the position of the own vehicle, the position of the other vehicle, and the position of the merging point on a map.

This configuration helps to allow the driver of the own vehicle to easily grasp the merging point and a traveling position of the other vehicle.

In some embodiments, the display apparatus 1 may include the merging data transmitter 18 configured to transmit, to the other vehicle, the data on the merging point, the required time of the own vehicle, and the required time of the other vehicle.

This configuration helps to allow a driver who drives the other vehicle to acquire the information on the position of the merging point, the required time of the own vehicle, and the required time of the other vehicle, which in turn helps to allow a driving situation to be shared between the vehicles.

The display apparatus 1 according to the example embodiment automatically transmits, to the other vehicle, the data on the merging point, the required time of the own vehicle, and the required time of the other vehicle. Accordingly, the display apparatus 1 helps to allow the driver of one vehicle of the vehicles to travel while recognizing traveling information of the other vehicle.

### Modification Example 1

The display apparatus 1 may be configured by a processor that is included in the navigation device 100 and executes the processes to be performed by two or more of the another vehicle data acquirer 13, the merging point detector 14, the required time calculator 15, the display information generator 16, and the controller 17 of the display apparatus 1 according to the example embodiment.

### Modification Example 2

The display apparatus 1 according to the example embodiment may update the data on the required time of the own vehicle and the required time of the other vehicle at predetermined time intervals.

This configuration helps to allow the driver of each vehicle to continuously grasp a change in the traveling state.

### Modification Example 3

The display apparatus 1 according to the example embodiment may update the required time of the own vehicle and the required time of the other vehicle and notify the driver of the own vehicle of updated information, when the required time to the merging point becomes different from the calculated required time due to a factor such as a traffic congestion.

This configuration helps to allow the driver of the own vehicle to continuously grasp a change in the traveling state.

### Modification Example 4

The display apparatus 1 according to the example embodiment may provide the driver of the own vehicle with voice information as well when the information on the merging point, the required time of the own vehicle, and the required time of the other vehicle is to be displayed on the display 40.

This configuration helps to allow the the driver of the own vehicle to easily grasp the merging point and the traveling state of the other vehicle.

### Modification Example 5

The display apparatus 1 according to the example embodiment may allow the driver of the own vehicle to customize a display mode of the display 40.

This configuration helps to allow information to be displayed on the display 40 based on the display mode that matches the preference of the driver of the own vehicle, and to allow the driver of the own vehicle to more easily grasp the traveling state.

In some embodiments, it is possible to implement the display apparatus 1 of the example embodiment of the disclosure by recording the process to be executed by one or more of the merging point detector 14, the required time calculator 15, the display information generator 16 on a non-transitory recording medium readable by a computer system, and causing the computer system to load the program recorded on the non-transitory recording medium onto the memory 20 to execute the program.

The computer system as used herein may encompass an operating system (OS) and a hardware such as a peripheral device.

In addition, when the computer system utilizes a World Wide Web (WWW) system, the “computer system” may encompass a website providing environment (or a website displaying environment).

The program may be transmitted from a computer system that contains the program in a storage device or the like to another computer system via a transmission medium or by a carrier wave in a transmission medium.

The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system.

According to at least one embodiment of the disclosure, it is possible to notify a driver who drives an own vehicle of information such as information on a merging point of vehicles that travel in a group or information on a time at which the vehicles arrive at the merging point.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The processor 10 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 10 illustrated in FIG. 1.

1. A display apparatus configured to be applied to a first vehicle, the display apparatus comprising:
a traveling route acquirer configured to acquire a traveling route of the first vehicle to a destination;
a vehicle data acquirer configured to acquire a traveling route of a second vehicle to the destination and position data of the second vehicle;
a merging point detector configured to detect a merging point, based on the traveling route of the first vehicle to the destination and the traveling route of the second vehicle to the destination;
a required time calculator configured to calculate, at predetermined time intervals, a difference between a first vehicle required time and a second vehicle required time, the first vehicle required time comprising a time required for the first vehicle to reach the merging point, the second vehicle required time comprising a time required for the second vehicle to reach the merging point;
a display information generator configured to generate display information on the merging point and the difference between the first vehicle required time and the second vehicle required time; and
a display configured to display the display information.

2. The display apparatus according to claim 1, wherein the display information generator is configured to generate the display information that comprises: a position of the destination; a position of the first vehicle; a position of the second vehicle; a position of the merging point; and
the difference between the first vehicle required time and the second vehicle required time.

3. The display apparatus according to claim 1, further comprising a merging data transmitter configured to transmit, to the second vehicle, data on the merging point, the first vehicle required time, and the second vehicle required time.

4. The display apparatus according to claim 2, further comprising a merging data transmitter configured to transmit, to the second vehicle, data on the merging point, the first vehicle required time, and the second vehicle required time.

5. A display apparatus configured to be applied to a first vehicle, the display apparatus comprising:
one or more processors;
one or more memories communicably coupled to the one or more processors; and
a display, wherein
the one or more processors are configured to
acquire a traveling route of a first vehicle to a destination,
acquire a traveling route of a second vehicle to the destination and position data of the second vehicle,
detect a merging point, based on the traveling route of the first vehicle to the destination and the traveling route of the second vehicle to the destination,
calculate, at predetermined time intervals, a difference between a first vehicle required time and a second vehicle required time, the first vehicle required time comprising a time required for the first vehicle to reach the merging point, the second vehicle required time comprising a time required for the second vehicle to reach the merging point,
generate display information on the merging point and the difference between the first vehicle required time and the second vehicle required time, and
display the display information on the display.
